(19) United States
(12) Patent Application Publication
(10) Pub. No.: US 2012/0080467 A1
(43) Pub. Date: Apr. 5, 2012

(54) SLIDING SUPPORT FOR A TRANSPORTABLE BARBEQUE

(75) Inventors: Christopher IRWIN, Medicine Hat (CA); Daniel ISELY, Calgary (CA); Tyler MAYO, Medicine Hat (CA); Geoffrey MAYO, Medicine Hat (CA)

(73) Assignee: CONCUSSION OILFIELD SERVICES LTD, Calgary (CA)

(21) Appl. No.: 13/253,673

(22) Filed: Oct. 5, 2011

Related U.S. Application Data
(60) Provisional application No. 61/389,942, filed on Oct. 5, 2010.

(51) Int. Cl. B60R 9/00

(52) U.S. Cl. 224/403; 224/542

(57) ABSTRACT

A transportable barbeque support and combination allows for safe transport and easy sliding access to a full size barbeque, fuel tanks, and coolers. A base is mounted securely to the truck bed, trailer, or RV and a sliding frame is movable thereon for movement between a transport position and an operating position. The barbeque is fit to a distal end of the sling frame and storage including fuel tanks at an inside or proximal end. A heat shield can be positioned between the barbeque and storage. A locking mechanism between the sliding frame and base ensures the barbeque remains securely in either the transport or operative positions.

### CROSS-REFERENCE TO RELATED APPLICATIONS

This application claims the benefits under 35 U.S.C 119(e) of the U.S. Provisional Application Ser. No. 61/389,942, filed on Oct. 5, 2010, which is incorporated fully herein by reference.

### FIELD OF THE INVENTION

Embodiments of this invention relate to supports for barbeques (BBQ) conveyed on a vehicle. More particularly, embodiments relate to sliding supports for use on a bed of a truck or trailer or in a recreational vehicle (RV) for sliding a barbeque between a transport position for storing and transporting a BBQ and an operative position for using the BBQ.

### BACKGROUND OF THE INVENTION

Food prepared and cooked over an open flame is enjoyed by many, and is an activity that is typically enjoyed during the summer months. Open fires, such as a camp fire, and the like are commonly used. However, open fires is inherently dangerous. Open fires also require the use of firewood or charcoal to provide a sustaining source of heat for cooking the food. Having a ready source of firewood and/or charcoal, and starting an open fire using wood and/or charcoal can be inconvenient to many. Furthermore, local fire regulations dictate whether or not the use of an open fire is permitted during certain times of the barbeque season.

Accordingly, gas-fueled barbeques (BBQ), such as liquid propane barbeques, are commonly used instead of open fires. Propane BBQ's are convenient to start up, and do not have the inherent dangers of an open flame associated with it.

Smaller and more portable BBQ's have been used for picnics, outdoor family outings and/or at tailgate parties. Unfortunately, portable BBQ's inherently have a small cooking surface. While desirable, full size BBQ's are bulkier, heavier and generally not readily transportable. Even users of recreational vehicles (RV's) are limited to using small, portable BBQ's because full sized BBQ's are not readily transportable.

To enjoy a large cooking surface, transportation of full-sized backyard barbeques is required. The transportation of and setting up of full sized BBQ's can often be clumsy, cumbersome and even dangerous.

### SUMMARY OF THE INVENTION

A sliding support for a full sized barbeque is disclosed. The sliding support allows for easy storage of the barbeque for transportation and easy access to the barbeque, fuel tanks, and coolers without having to remove the barbeque, fuel tanks, or coolers from the support. The barbeque, associated fuel tanks, and coolers for food can be operatively supported by the sliding support.

Generally, the support comprises a base adapted to be mounted to a vehicle, and a sliding frame movably supported on the base, the access end or distal end of which is operable between a storage position for transporting the barbeque, fuel tanks and coolers, and an operating position for using the barbeque and gaining ready access to the fuel tanks and coolers. The BBQ can be supported on the sliding support which is mounted onto a bed of a truck or trailer, or into an RV. The sliding support allows the BBQ, fuel tanks, and coolers to roll out for easy access by the user, from its transport position to its operating position easily for access by a user.

In a broad aspect, the sliding support comprises a base adapted to be mountable to a vehicle, and a sliding frame movably supported on the base and adapted to support a barbeque thereon. The sliding frame is operable between a transport position for transporting and storing the barbeque and an operating position for providing ready access to the barbeque.

In another broad aspect, a transportable barbeque support comprises a base adapted for mounting to a vehicle and a sliding frame slidably mounted to the base, the slidable frame having an inside or proximal end and an access or distal end, the sliding frame slidable relative to the base for moving the distal end from a transport position to an operational position. A barbeque mount being adjacent the frame's distal end receives the barbeque wherein, in the transport position, the barbeque is stored within the vehicle and in the operational position the barbeque is at least partially extended from the vehicle for access thereto. A storage area is adjacent the frame's proximal end and a heat shield intermediate the barbeque mount and the storage area.

In another broad aspect, a combination of a vehicle and a support for a transportable barbeque comprises a base mounted to the vehicle; a sliding frame slidably mounted to the base, the slidable frame having a proximal end and a distal end, the sliding frame slidable relative to the base for moving the distal end from a transport position to an operational position; and a barbeque mount for supporting the transportable barbeque, the barbeque mount being adjacent the distal end wherein in the transport position the frame's distal and barbeque mount is stored within the vehicle and in the operational position the barbeque is at least partially extended from the vehicle. The combination can further comprise brackets and fasteners for securing to the vehicle, locking means to secure the sliding frame in transport and operating positions.

### BRIEF DESCRIPTION OF THE DRAWINGS

FIG. 1 is a perspective front view of an embodiment of a transportable barbeque supported on a sliding frame further illustrating a heat shield and deployed foldable side tables;

FIG. 2A is a perspective back view of the transportable barbeque according to FIG. 1 further illustrating supports for securing fuel tanks and accessories such as coolers;

FIG. 2B is a perspective back view of the transportable barbeque according to FIG. 2A with fuel tanks and coolers supported therein;

FIGS. 3A, 3B and 3C are side views of a truck fit with an embodiment of a sliding support and a transportable barbeque shown in the transport or stored position, a operative position and the operative position having side tables deployed;

FIG. 4 is an front view of the transportable barbeque according to the FIG. 2B shown fit in the box of a pick-up truck, a front view of the transportable barbeque being a rear view of the truck;

FIG. 5 is a partial perspective view of a distal end of a sliding frame having a barbeque thereon and one embodiment of deployable side table shown in exploded view and poised for storage in the upright stored position and poised for deployment into the table supports in the horizontal deployed position;

FIG. 6A is a partial front view of the deployable side table of FIG. 5 shown in exploded view from the table supports;

FIG. 6B is a partial front view of another embodiment of deployable side tables having a hinged side table shown in an upright stored position and in a deployed position (dotted lines);

FIG. 7 is a plan view of one embodiment of a base and a sliding frame movably supporting transportable barbeque thereon, the sliding frame having been moved to the operating position;

FIG. 8 is a plan view of the base according to FIG. 7;

FIG. 9A is a plan view of the sliding frame according to FIG. 8;

FIG. 9B is a partial perspective view of an embodiment of a locking means according to FIGS. 8 and 9A;

FIG. 10 is a perspective plan view of another embodiment of a base secured within a box of a pickup truck (partial view), the base having alternate locking means and forklift pockets formed therein;

FIG. 11 is a front view of the base of FIG. 8 illustrating parallel bottom rails interconnected by laterally extending supporting members each bottom rail having a guide track and a bottom roller;

FIG. 12 is a front view of the sliding frame of FIG. 9A illustrating the parallel top rails interconnected by laterally extending supporting members, each top rail having a guide track and a top roller;

FIG. 13 is a side view of a sliding frame being engaged with a base;

FIG. 14 is a side view of the sliding frame engaged with the base according to FIG. 13, the sliding frame cantilevered from the base on the bottom and top rollers, the sliding frame being shown in the operating position;

FIG. 15 is a side view of the sliding frame engaged with the base according to FIG. 13, the sliding frame being shown in the transport position;

FIG. 16 is a close up end view of the bottom and top rollers of the base and sliding frame respectively, the sliding frame shown in dotted lines; and

FIG. 17 is a view of a sliding frame in the operating position, supporting a barbeque extended from the side of a fifth-wheel recreational trailer.

### DESCRIPTION OF PREFERRED EMBODIMENTS

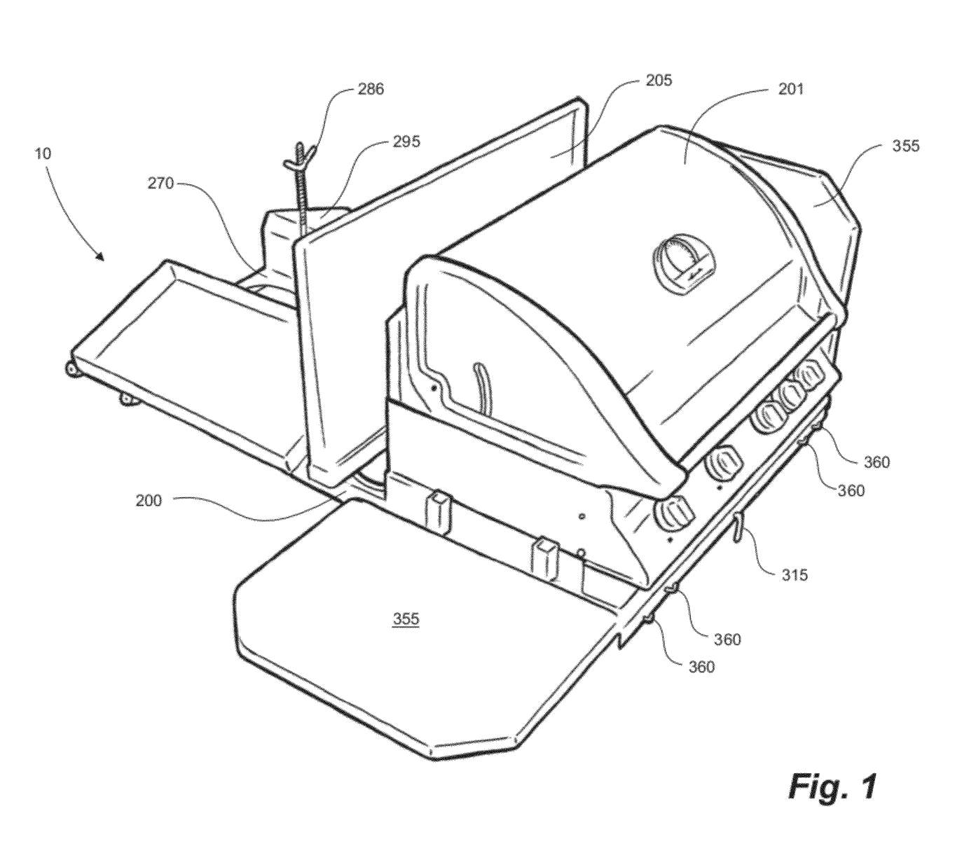

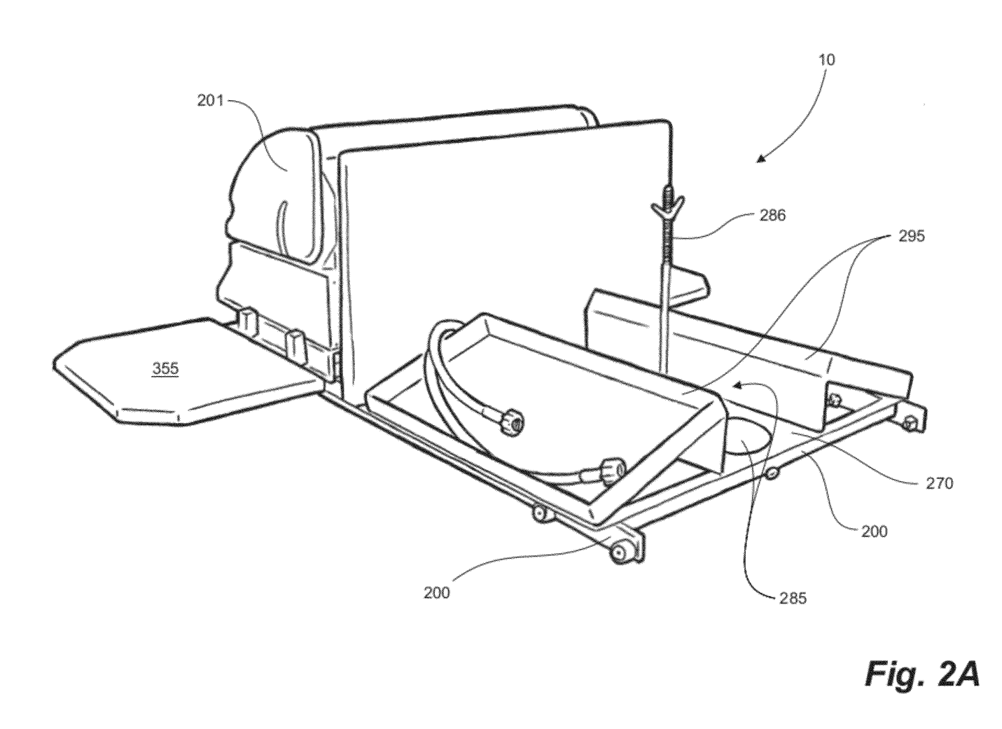

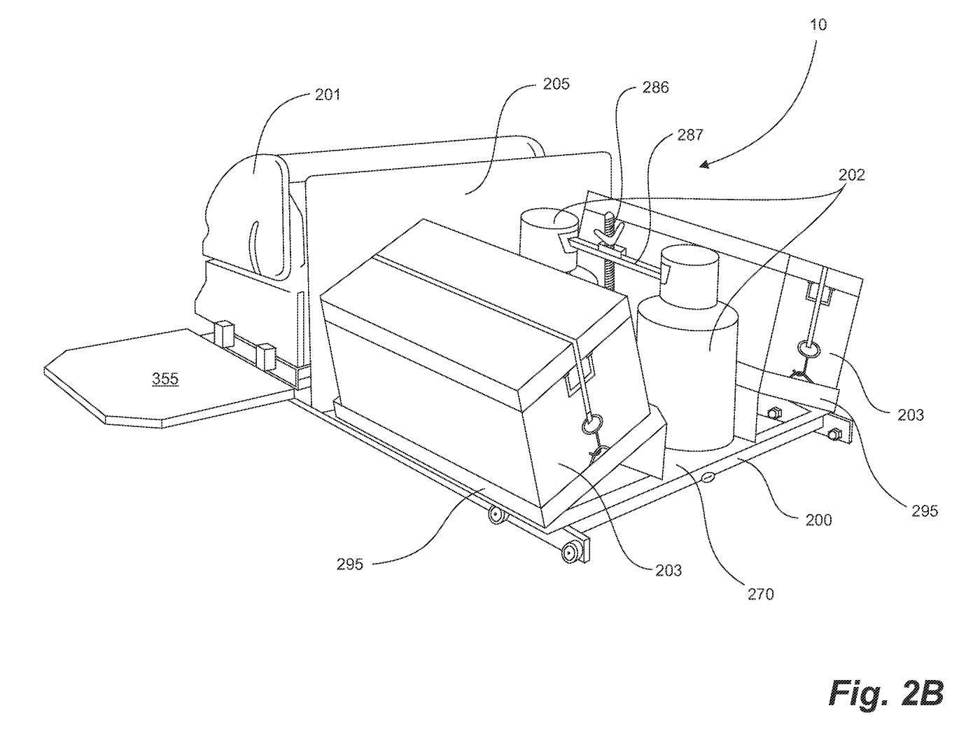

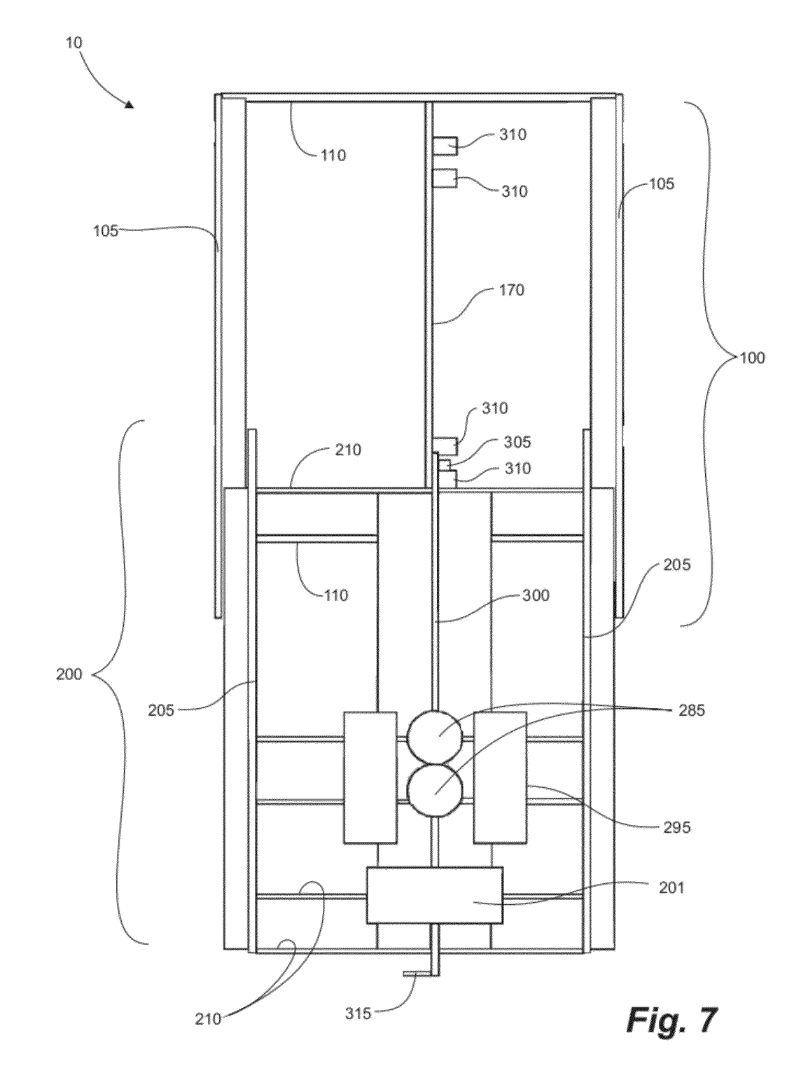

With reference to FIGS. 1, 2A and 2B, a barbeque (BBQ), such as a full size BBQ, is shown supported on a sliding frame for transport, and movable positioning, on a vehicle. The sliding frame is part of an overall sliding support 10 comprising a base 100 (FIG. 7) secured to the vehicle and the sliding frame 200 which supports the BBQ. As described later, the base 100 is adapted for being secured to the vehicle such as to the structure of truck, trailer, or recreational vehicle (RV).

As shown in FIG. 2B, the sliding frame 200 supports the BBQ 201 at an access end or distal end of the sliding frame 200 and can also secure associated fuel tanks 202 for the BBQ and storage such as coolers 203 for storing beverages or other food items therein. The BBQ 201 and other components 202,203 . . . are secured to the sliding frame 200. Depending upon the proximity of the fuel tanks 202 and coolers 203 to the BBQ 201, the sliding frame 200 can further comprise a heat shield 205 between the BBQ 201 and heat sensitive components. With reference to FIG. 1 the sliding frame 200 can also comprise various accessories such as tool hooks 360, 360 . . . and other storage areas, drawers or compartments for storing utensils and other BBQ accessories.

As shown in FIGS. 1 and 2A, the sliding frame 200 itself or one or more support mounts or surfaces supported on the frame 200 can be provided for particular support of accessories including the fuel tanks 202 and coolers 203. The sliding frame has a proximal end remaining adjacent the vehicle and a distal end movable from adjacent the vehicle to a point extended from the vehicle. As shown, a central supporting panel 270 extends along a middle of the frame 200 and comprises one or more openings 285, for receiving base rings of conventional propane tanks 202 and securing them against horizontal movement. Shown in FIG. 2B, a clamp 286, having a clamp bar 287 can batten down one or two propane tanks 202 to the sliding frame 200. Further still, in an embodiment, the central supporting panel 270 can also be adapted to secure storage containers such as coolers 203 thereon. As shown, cooler supporting surfaces 295,295 can be positioned adjacent the openings 285,285 for receiving storage in order to efficiently use any available space on the sliding frame 200. In an embodiment, two cooler supporting surfaces 295,295 spaced laterally within the sliding frame and angled away from each other for ease of access from either side of the sliding frame 200. The supporting surface 295,295 are spaced sufficiently to locate one or more fuel tanks 202,202 therebetween.

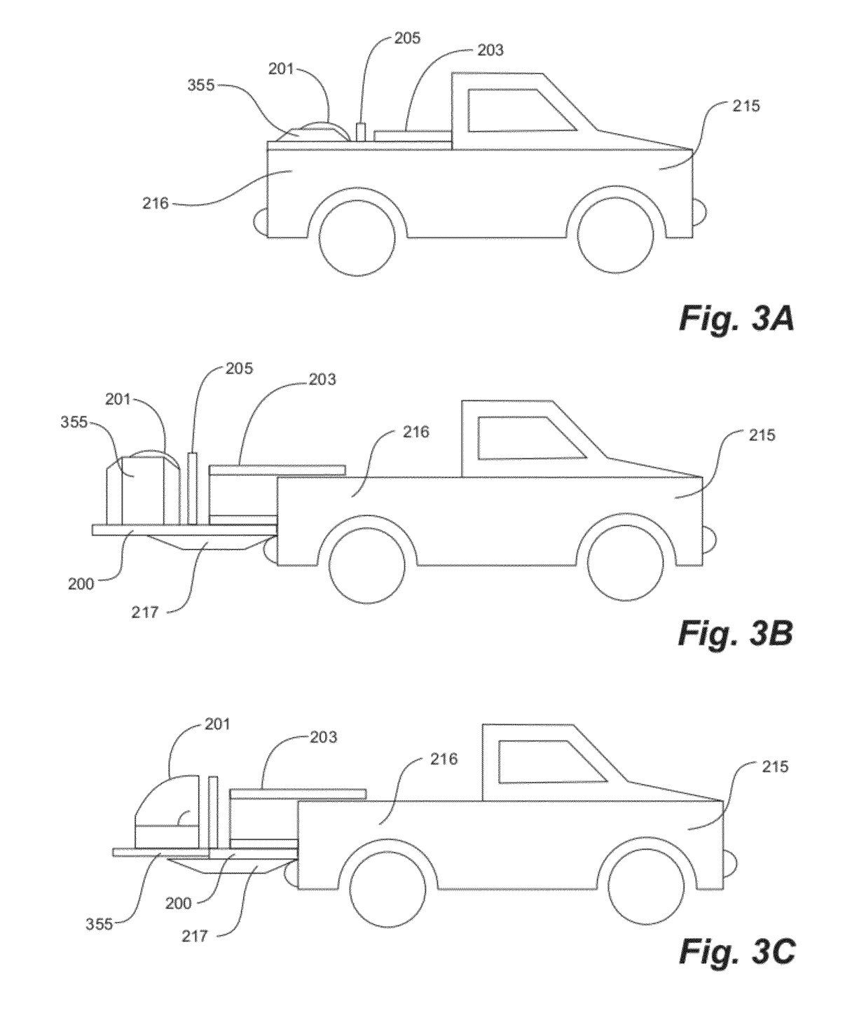

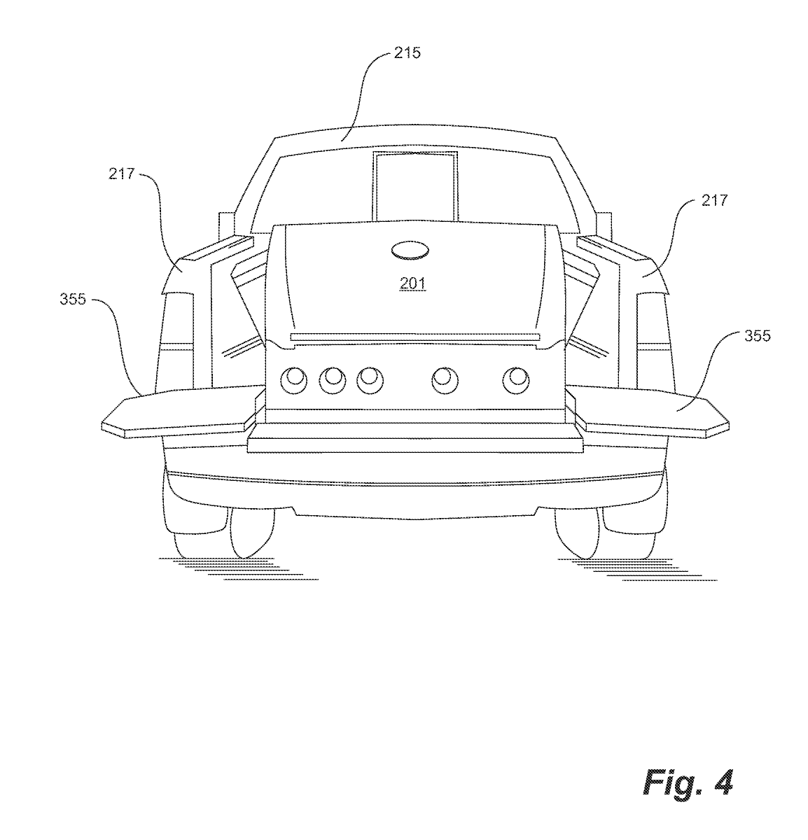

As shown in FIGS. 3A through 3C, in the context of a pickup truck 215, the sliding frame 200 is movable on the base 100 and operable for moving the distal end between a transport position (FIG. 3A) for storing and transporting the BBQ wholly within the truck bed 218, and an operating position (FIGS. 3B,3C) for providing ready and safe access to the BBQ. In the transport position, the BBQ 201 is stored within the vehicle and in the operational position the BBQ 201 is at least partially extended from the vehicle for access thereto. In further embodiments, the sliding frame 200 comprises side tables 355, located adjacent the BBQ 201, and which are deployable from a stored to a deployed position for additional convenience. In the operating position, side tables 355 are typically deployable without interference with the structure of the vehicle. As shown, in the context of a pickup truck 215, tailgate 217 is lowered and the sliding frame 200 and BBQ 201 are extended rearward of the truck box and moved to the operating position free of the box sidewalls 216. The one or two side tables 355 are deployable from an upright stored position (FIG. 3B) to a horizontal deployed position (FIG. 3C) without contacting the side walls.

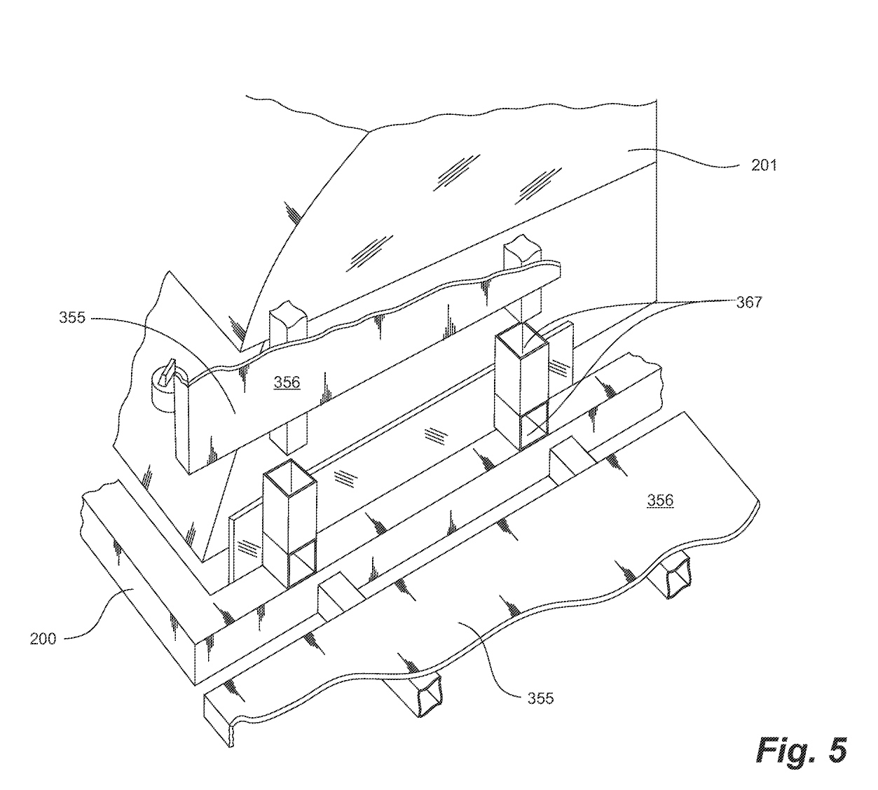

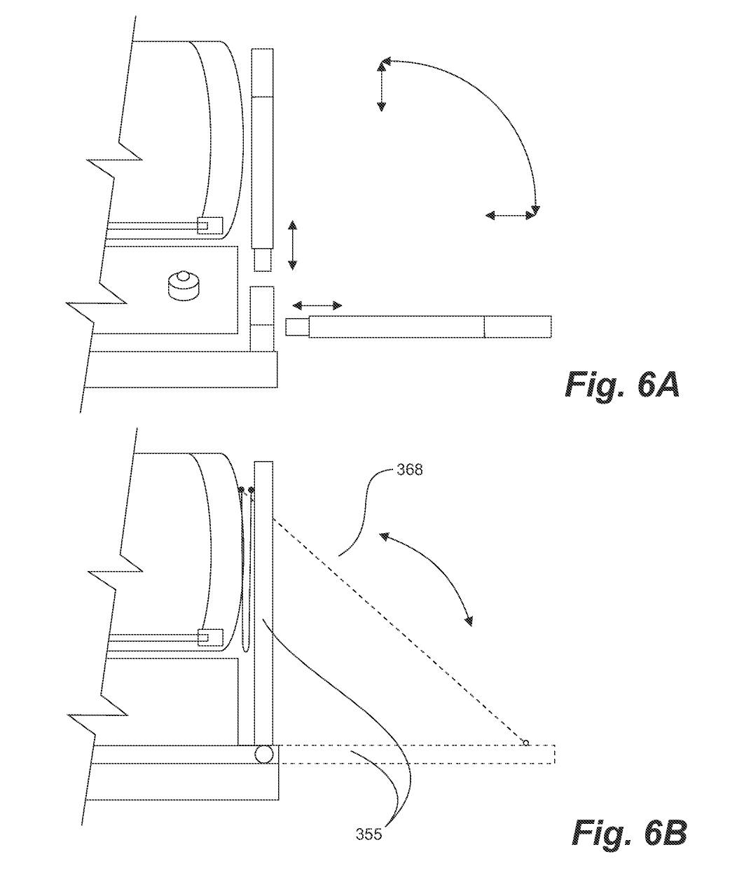

With reference to FIGS. 5 and 6A the side tables 355 are mounted and deployable on the distal end of the sliding frame 200. As shown, one embodiment of a side table 355 has a table surface 356, and a connection or interface comprising a pin 357 or pair of pins 357,357 corresponding to table supports 365 comprising socket 367 or sockets 367,367 supported on the frame 200. Alternatively, the location of the sockets 367 and pins 357 could be reversed, the pins being on the frame 200 and the sockets on the tables. A single pin 357 and socket 367 is usable if their corresponding cross-sections are irregular, such as that formed of square, polygonal or non-circular tubing. The pins 357,357 can be the distal ends of structural tubing 358 extending along the table 255. The table supports have upright sockets and horizontal sockets for storage and deployment respectively. The tubing 358 and sockets 367 are typically square tubing. FIG. 6A is a partial front view of the deployable side table of FIG. 5 shown in exploded view from the table supports. In another embodiment, shown in FIG. 6B, the table 355 is deployable by hinged connection 368 to the frame 200, pivoting from an upright stored position to a horizontal deployed position (dotted lines). A tension member 369, such as a chain or cable, extending between the frame 200 and table 355 adds to the table's carrying capacity in the deployed position.

Roll out cargo beds and liners are known for accessing truck beds such as those set forth in U.S. Pat. No. 6,312,034 to Coleman, II et al. and US published application 2005/0212317 to Kobylski. Such beds and liners might be converted for affixing applicant's elements of a BBQ 201 and accessories such as side tables, storage containers and the like. Applicant provides their own sliding support 10.

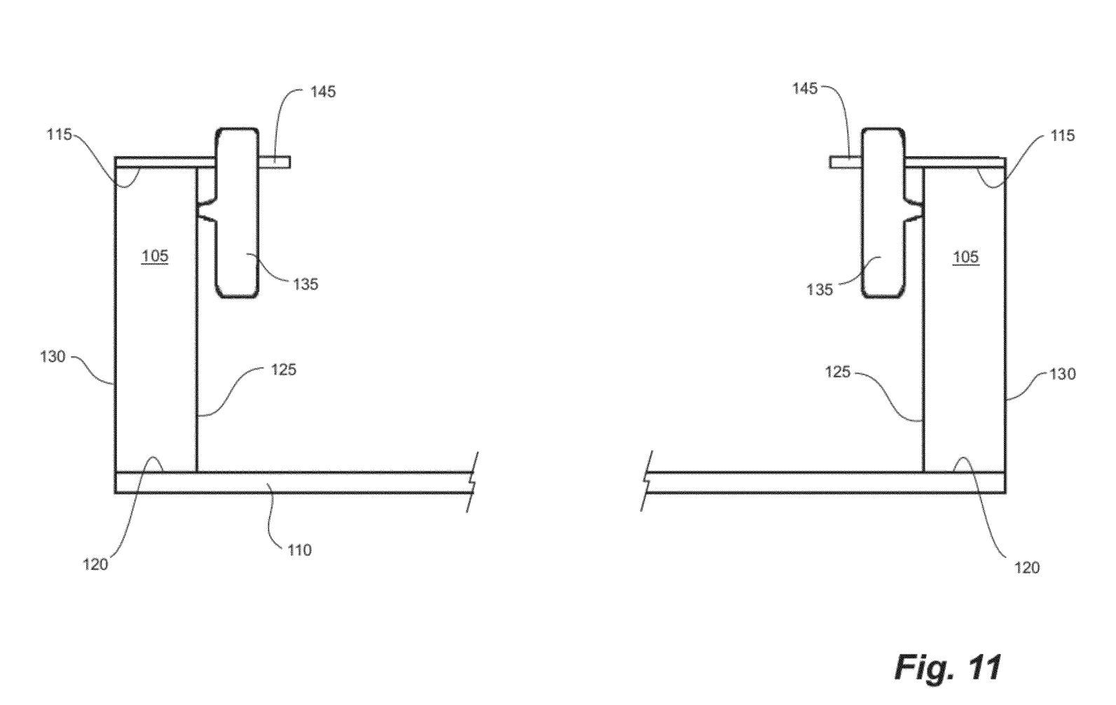

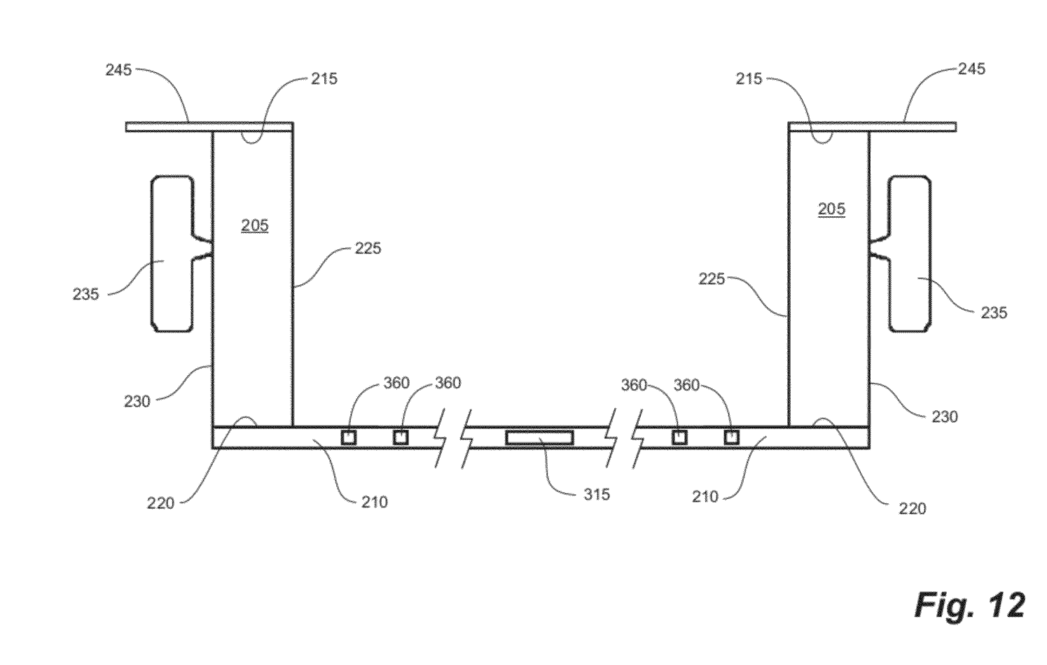

With reference to FIGS. 7 through 17, applicant's sliding support comprises base 100, secured to the vehicle by removable fasteners, and sliding frame 200 which is movable relative to the base 100. The sliding frame 200 is cantilevered from the base 100 for extending the BBQ 201 outside the envelope of the vehicle for access and operation. For example, where the vehicle is a pickup truck 215 (FIGS. 3A to 3C), the distal end of the frame 200 and BBQ 201 are moved and extended rearward of the truck 215 to the operating position beyond the truck's sidewalls 216. In an RV or fifth-wheel trailer (FIG. 17) the sliding frame 200 is moved from within the RV or trailer to a position outside the RV or trailer. The base 200 supports the cantilever loads.

Turning to FIG. 7 in greater detail, the sliding frame 200 is shown moved to the operating position relative to the base 100. The base 100 comprises two parallel and opposing bottom rails 105,105 for supporting the sliding frame (not shown) thereon. The two bottom rails 105,105 can be interconnected to one another by at least two supporting members 110,110 to cooperatively form a substantially rectilinear frame. In one embodiment, a central supporting member 170 can span from one of the at least two supporting members 110,110, to the other of the at least two supporting members 110,110 for increasing overall structural integrity and strength to the base 100. The sliding frame 200 comprises two parallel and opposing top rails 205,205 interconnected by at least two supporting members 210,210 for forming a substantially rectilinear frame for slidably moving along the two bottom rails of the base 100. In an embodiment, a central supporting panel 270 can span between the at least two supporting members 210,210 for increasing structural integrity of the sliding frame 200. A barbeque mounting surface 275 is positioned at a distal end 280 of the central supporting panel 270 for mounting the BBQ 201 thereon.

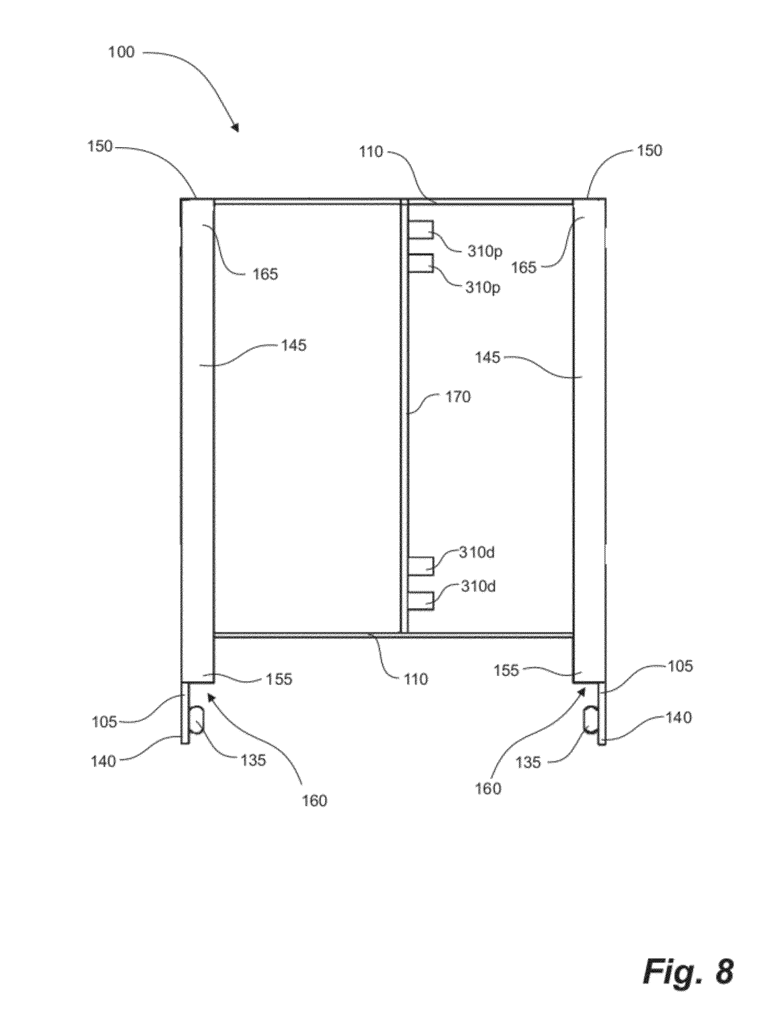

Turning to FIG. 8, in isolation, each bottom rail 105 of the base 100 further comprises a bottom roller 135 disposed at a first distal end 140 of the bottom rail 105 and a bottom guide track 145 that extends longitudinally along the length of the top 115 of the side rail 105 from about the bottom roller 135 to a second proximal end 150 of the bottom rail 105.

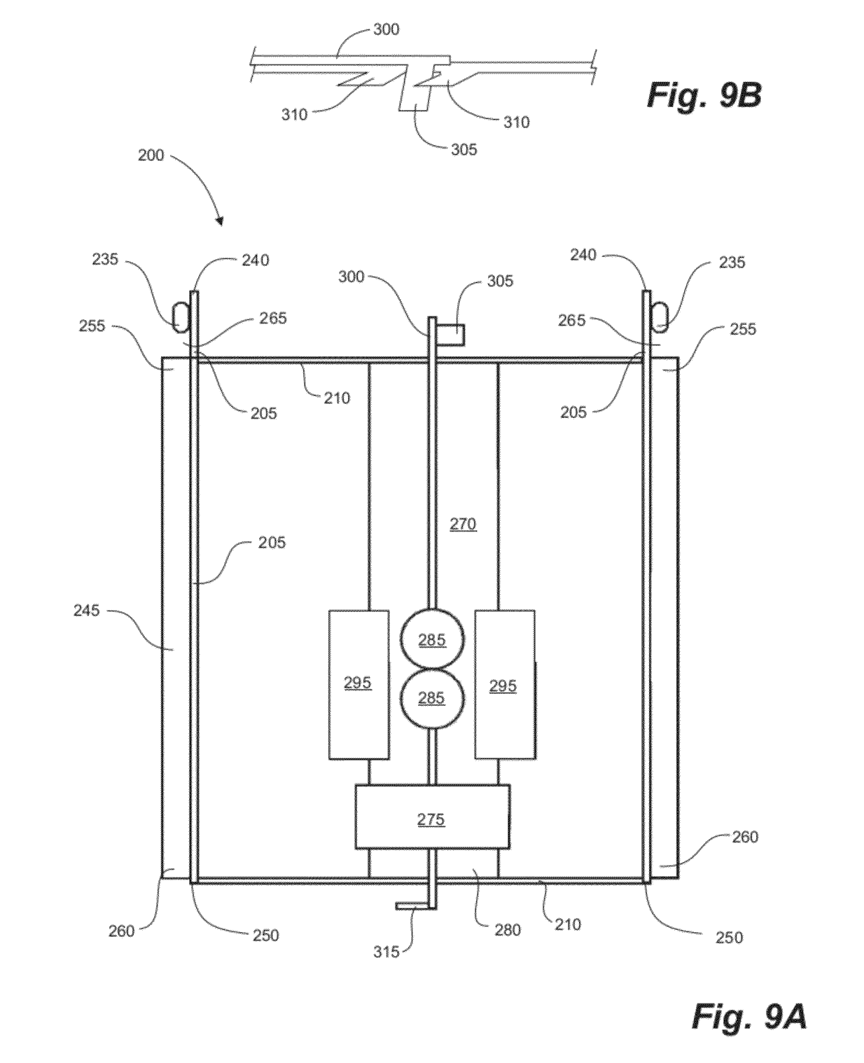

Turning to FIG. 9A, in isolation, each top rail 205 of the sliding frame 200 further comprises a top roller 235 disposed at a proximal end 240 of the top rail 205 and a top guide track 225 that extends longitudinally along the length of a top 215 of the top rail 305 from about the top roller 235 to a second distal end 250 of the top rail 205.

A distal end 155 of each bottom guide track 145 is spaced away from its respective bottom roller 135 for providing a bottom insertion gap 160 between the bottom track 145 and bottom roller 135 sufficient to allow the top rollers 235, and a portion of the sliding frame 200, to pass therethrough. Similarly, a proximal end 255 of each top guide track 245 is spaced away from its respective top roller 135 for providing a top insertion gap 265 therebetween sufficient to allow the bottom roller 135 to pass therethrough. In this embodiment, the arrangement of tracks 145, 245 and rollers 135,235 are such that the sliding frame 200 is nestled between the bottom rails 105,105. As shown in FIG. 2A and FIGS. 13 through 16, each top rail 205 can be provided with a weight distributing pair of top rollers 235, for a total of four on the sliding frame 200. The sliding frame 200 cannot slide free of or out of the base 100 once installed. When the frame 200 is fully extended, at least one of the top roller 235 remains engaged with the bottom guide track 145 and a distal-most top roller 235 abuts the bottom roller 135, avoiding accidental dropping of the sliding frame and components thereon.

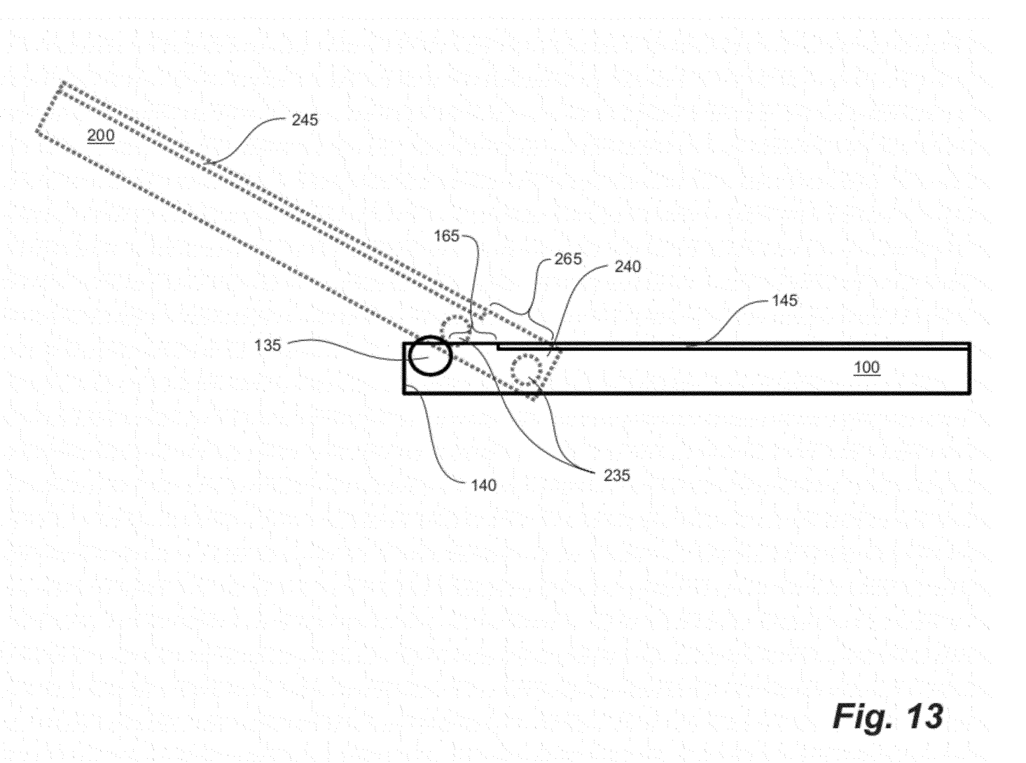

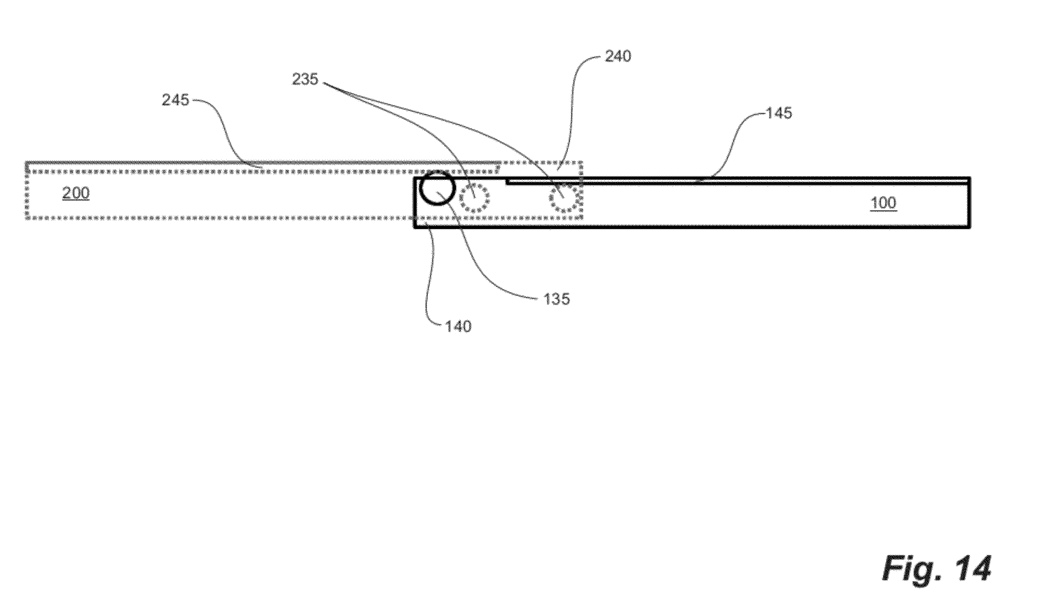

With reference to FIGS. 13 through 16, the sliding frame 200 (shown in dotted lines) is assembled with base 100. As shown in FIG. 13, the sliding frame 200 can be angularly oriented relative to the base 100. The first proximal end 240 of both top rails 205,205 and the top rollers 235,235 are passed through bottom insertion gaps 160,160 of the bottom rails 105,105. As shown in FIG. 14, the sliding frame 200 is then pivoted downward and substantially parallel to the base 100 to engage top rollers 235,235 with an underside of bottom guide tracks 145,145 and rest or engaged the top guide tracks 245,245 on bottom rollers 135,135.

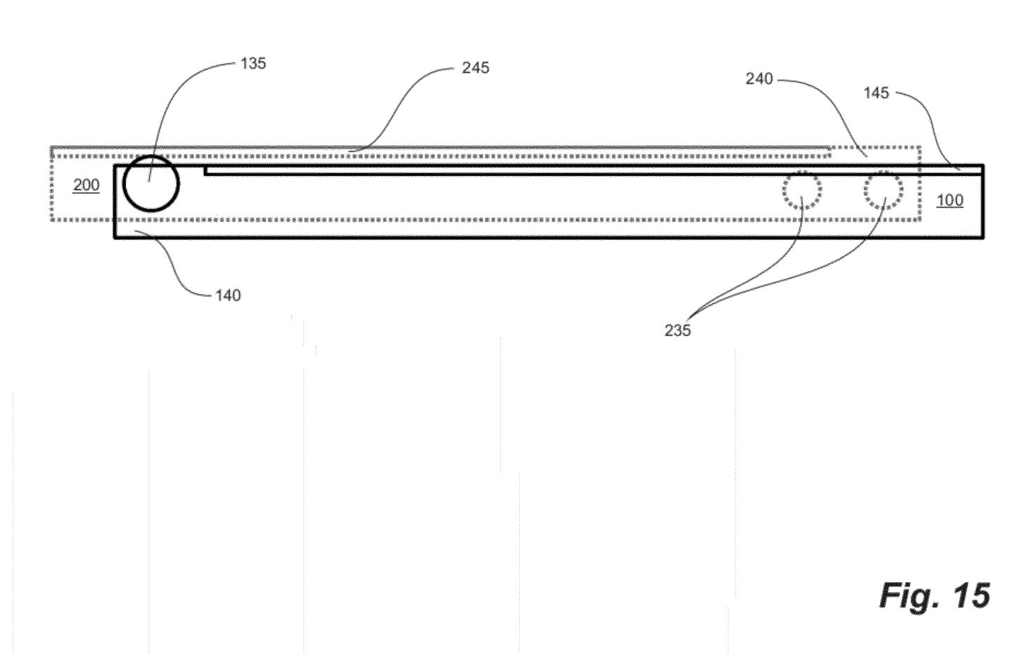

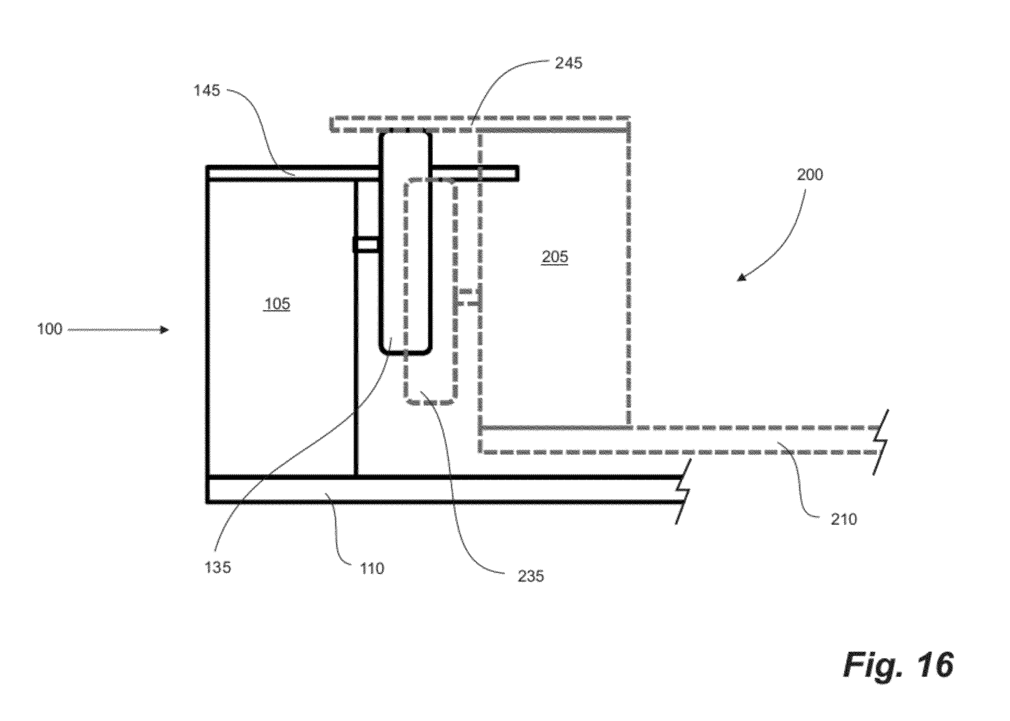

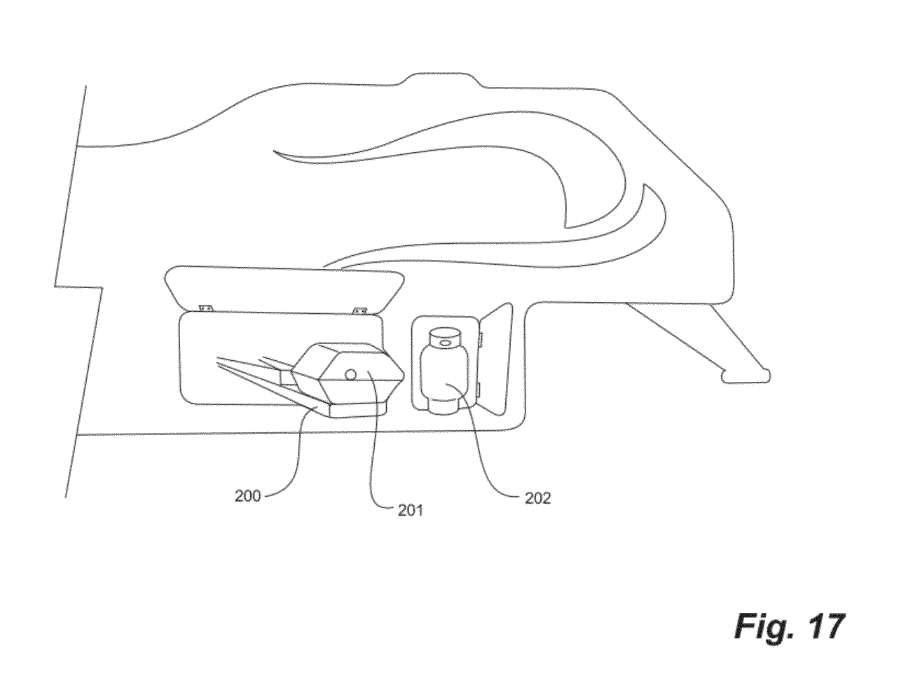

As shown in FIGS. 15 and 16, the top frame 200 can be leveled out to cause top rollers 235,235 to move or roll along the bottom guide tracks 145,145 and cause the bottom rollers 135,135 to engage the top guide tracks 245,245 of the sliding frame 200. As shown in FIG. 16, once the sliding frame 200 and the base 100 are interconnected, the sliding frame 200 is movable along the base 100, and can be operable between its storage position for storing and transporting a BBQ and an operating position for using the BBQ.

With reference also to FIG. 16, with the sliding frame 200 engaged with the base 100, the respective bottom and top rollers 135,235 rollably engage the respective top and bottom guide tracks 245, 145 respectively. Each top and bottom guide track 245,145 have a lateral width sufficient to form a track for receiving the rollers, the top roller 235 engaging an underside of bottom track 145 and the bottom roller 135 engaging an underside of top track 245. The bottom roller 135 is positioned along an inside surface 125 of its respective bottom rail 105, and the axis of which is located such that a rolling circumference extends above the bottom guide track 145. Thus, when the sliding frame 200 and the base 100 are movably interconnected, the top guide track 245 will be supported above the bottom guide track 145. As shown, the top roller 245 extends from an outside surface 230 and having an axis of which is located such that a rolling circumference is spaced below the top guide track 245, sufficient to pass the bottom guide track therebetween.

With reference to FIGS. 7 and 9B the sliding support 10 further has a locking means or frame lock 310 for securing the sliding frame 200 in either its transport position or its operating position. The sliding frame 200 is releasably locked to the base 100 in either position. As shown, one locking means can include a lock tab 305 operably from one of either the sliding frame 200 or base 100 which releasably engages between at least one lock stop located on the opposing base 100 or sliding frame 200. A pair of lock stops 310,310 prevents sliding in both the distal and proximal directions. As shown, the locking tab 305 is operable from the sliding frame 200 such as being pivotally actuable by locating the tab 305 on a rotatable shaft 300. The shaft 300 extends from the access or distal end of the sliding frame 200 to a termination point adjacent the frame's proximal end. The shaft 300 has a handle 315 located at the distal end, adjacent the BBQ 201. The shaft 300 is typically biased to the locked position, a user having to force the handle and lock tab to the released position, against a bias, to enable sliding movement of the frame 200 relative to the base 100. As shown in FIGS. 7 and 8, the central supporting member 170 can be adapted to have a first pair of lock stops 310p,310p at one proximal end thereof and a second pair of lock stops 310d,310d at an opposing distal end. As shown in FIG. 9B, each lock stop 310p,310p and 310d,310d, of each pair of locks are sufficiently spaced apart from one another to allow the lock tab 305 to engage therebetween. To secure the sliding frame 200 is either its storage position or its operating position; the sliding frame 200 is either rolled out or rolled in, and aligned with a respective pair of lock stops 310,310. The rotatable shaft 300 is then rotated to cause the lock tab 305 to engage and fit between the pair of lock stops 310,310.

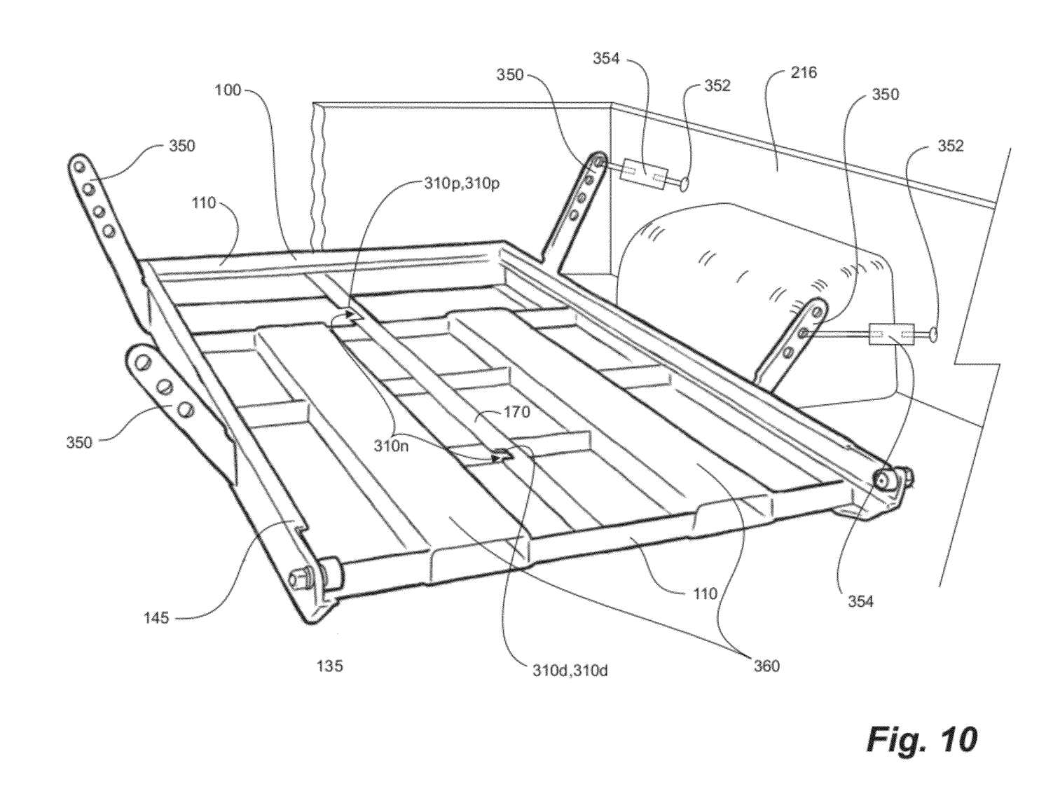

With reference to FIG. 10, another embodiment of the base 100 is shown comprising mounting brackets 350 for securely mounting the base 100 onto a vehicle, such as onto a bed of a truck or trailer, or a storage compartment of a recreational vehicle. The base is shown in the context of a pickup truck 215. The base 100 is secured by the brackets 350 to existing box hooks 352, such as those in the side walls 216 of the truck or after-market hooks. The brackets 350 can have a plurality of connection points for adapting to different locations of box hooks 352. As shown, fasteners such as turnbuckles 354 or the like can adjustably secure the brackets 350 to the box hooks 352. For ease of assembly, the base can also be provided with forklift pockets for manipulating the base 100, or assembled base 100 and sliding frame 200, or assembled base 100, sliding frame 200 and BBQ 201. A forklift can lift one or more the components onto or into the vehicle. Again, a frame lock 310 is provided for securing the sliding frame 200 in either its transport position or its operating position. A lock tab is operable from the sliding frame 200 and a member of the base 100, such as a central supporting member 170, can be formed with a notch 310n for forming a first pair of lock stops 310p,310p at one proximal end thereof and a second notch 310n for forming a second pair of lock stops 310d,310d at an opposing distal end.

The variety of embodiments disclosed therein, utilizing sliding support 10 and one or more combinations of base 100, sliding frame 200, barbeque and storage features, enable adaptation to trucks boxes, trailers and RVs, without modification of the transportable BBQ assembly. All components can be provided in one package including the BBQ, fuel tanks, storage such as coolers, and condiment and working surface side tables. The fuel is securely and safely stored without the need for attaching and detaching for use. The provided locking system renders the assembly safe for transport and operation. In a pickup truck embodiment, the transportable BBQ can fit entirely within a truck box, for closing of the tailgate in a transport position and all components are contained to avoid inadvertent loss. Further embodiments of the base, having multi-position brackets and fasteners such as turnbuckles makes adaptability to a variety of vehicles easy and reliable and in most cases without modifications to the vehicle.

The embodiments of the invention for which an exclusive property or privilege is claimed are defined as follows:

1. A transportable barbeque support comprising:
a base adapted for mounting to a vehicle;
a sliding frame slidably mounted to the base, the slidable frame having a proximal end and a distal end, the sliding frame slidable relative to the base for moving the distal end from a transport position to an operating position;
a barbeque mount, adjacent the frame's distal end, for receiving the barbeque wherein, in the transport position, the barbeque is stored within the vehicle and in the operating position the barbeque is at least partially extended from the vehicle for access thereto;
a storage area adjacent the frame's proximal end; and
a heat shield intermediate the barbeque mount and the storage area.

2. The barbeque support of claim 1 wherein
the base is adapted for mounting to a truck bed; and
the sliding frame is movable to the transport position wholly within the truck bed.

3. The barbeque support of claim 1 wherein the storage area comprises two supporting surfaces for receiving storage containers, the supporting surface being spaced laterally within the sliding frame and angled away from each other for ease of access from either side of the sliding frame.

4. The barbeque support of claim 3 wherein the supporting surfaces are spaced sufficiently to locate one or more fuel tanks therebetween.

5. The barbeque support of claim 1 further comprising one or more side tables at the distal end of the sliding frame, each side table operable between an upright stored position and a horizontal deployed position, comprising:
a table; and
a connection for moving the table between the stored and deployed positions.

6. The barbeque support of claim 5 wherein the connection comprises corresponding pins and sockets oriented vertically and horizontally.

7. In combination:
a vehicle; and
a sliding support for a transportable barbeque, the sliding support comprising;
a base mounted to the vehicle;
a sliding frame slidably mounted to the base, the slidable frame having a proximal end and a distal end, the sliding frame slidable relative to the base for moving the distal end from a transport position to an operating position; and
a barbeque mount for supporting the transportable barbeque, the barbeque mount being adjacent the distal end wherein, in the transport position, the frame's distal end barbeque mount is stored within the vehicle and in the operating position the barbeque is at least partially extended from the vehicle.

8. The combination of claim 7 wherein
the base further comprises
a pair of proximal brackets for mounting the base to the proximal end of a truck bed;
a pair of distal brackets for mounting the base to the distal end of the truck bed;
the truck bed further comprises at least a pair of proximal bed hooks and at least a pair of distal bed hooks,
wherein, the base is secured to the truck bed between the proximal brackets and proximal and between the distal brackets and distal hooks.

9. The combination of claim 7 wherein the base further comprises a pair of parallel forklift pockets extending from the distal end towards the proximal end.

10. The combination of claim 7 further comprising:
a frame lock between the base and the sliding frame, the lock comprising:
a lock tab, and
at least a first lock stop wherein the lock tab engages the lock stop for securing the sliding frame from movement relative to the base.

11. The combination of claim 10 wherein
the base has a proximal end and a distal end, and
the frame lock further comprises:
a pair of proximal lock stops adjacent the proximal end of the base; and
a pair of distal lock stops adjacent the distal end of the base; and
the lock tab is pivotally actuable from the sliding frame for alternatively engaging the pair of proximal lock stops in the transport position and engaging the pair of distal lock stops in the operating position.

12. The combination of claim 7 wherein the vehicle is a truck having a truck bed and a tail gate, and when in the transport position, the tail gate is closed to secure the sliding frame wholly within the truck bed.

13. The combination of claim 7 wherein the proximal end of the sliding frame further comprises storage area.

14. The combination of claim 7 wherein the sliding frame further comprises a heat shield for isolating the barbeque from the storage area.

15. The combination of claim 7 further comprising one or more side tables located at the distal end of the sliding frame, each side table movable between a substantially upright storage position and a substantially horizontal deployed position.

16. The combination of claim 15 wherein each side table further comprises a table surface and a connection between the sliding frame and the table surface the connection comprising corresponding pins and sockets oriented vertically and horizontally.

17. The combination of claim 7 wherein
the base further comprises two parallel and opposing bottom rails, each of the two bottom rails further comprising a distal end, an opposing proximal end and a bottom roller disposed on an inside surface adjacent the distal end, and a bottom guide track extending longitudinally along a top surface of the bottom rail and from about the bottom roller to the second proximal end, extending along a top surface of the bottom rail;
the sliding frame further comprises two parallel and opposing top rails, each of the two top rails further comprising a first distal end, an opposing proximal end, at least one top roller disposed on an outside surface adjacent the second proximal end, and a top guide track extending longitudinally from about the at least one top roller to the first distal end; and
wherein the top rollers movably engage undersides of the bottom guide tracks and the bottom rollers movably engage undersides of the top guide tracks.
